(19) United States
(12) Patent Application Publication
(10) Pub. No.: US 2007/0128442 A1
(43) Pub. Date: Jun. 7, 2007

(54) Materials composites of a moulded article of transparent or translucent dyeable plastics moulding compounds

(76) Inventor: Friedrich Severin Buehler, Thusis (CH)

Correspondence Address: John B Hardaway III;Nexsen Pruet, P O Box 10107, Greenville, SC, 29603, US

(21) Appl. No.: 10/587,919

(22) PCT Filed: Jan. 31, 2005
(86) PCT No.: PCT/EP05/50392

§ 371 Date: Aug. 2, 2006

(30) Foreign Application Priority Data
Feb. 3, 2004 (EP) 04002353.3

(51) Int. Cl. B32B 9/04

(52) U.S. Cl. 428/411.1

(57) ABSTRACT

The present invention relates to materials composites of a moulded article of at least one transparent or translucent dyeable plastics moulding compound which moulded article is bonded to at least one transparent or translucent surface layer and/or to decorative films, functional films or coats or rubbers or other plastics, wherein the plastics moulding compound used for the manufacture of the moulded article, the surface layer or the other plastics contains in an amount of 0.01 to 5.0% by weight, preferably 0.01 to 2.0% by weight, each related to the total weight of the moulding compound, at least one lubricant selected from the group consisting of sorbitan esters, sebacic acid esters, dodecanedioic acid esters, docosanoic acid esters, glycerine, glycol, diethylene glycol, stearoyl amide, stearyl stearate, ethylene bissteroyl amide, octane pyrrolidone, and from the group consisting of non-polar paraffin oils and of tetracosanes, and wherein a permanent adhesion to the other plastics layers and/or sheets or coats or rubbers or other plastics is achieved.

### BACKGROUND OF THE INVENTION

1. Field of the invention

The present invention relates to the subject matter specified in the patent claims. More specifically, the invention therefore relates to materials composites of a moulded article of at least one transparent or translucent dyeable plastics moulding compound which moulded article is bonded to at least one transparent or translucent surface layer and/or to decorative films, functional films or coats or rubbers or other plastics. The plastics moulding compounds used exhibit qualities which have so far been achievable only with PMMA, polycarbonate (PC) or curable casting materials. The plastics moulding compounds used for the materials according to the invention are in particular polyamide moulding compounds. They contain lubricants which do not impair the adhesion to other components. The materials composites according to the invention may be used for optical components such as ophthalmic lenses or sun lenses for eyeglasses, magnifier lenses, lens systems, microscopes, cameras, displays for mobile cellular telephones, camera lenses, measuring instruments, watch-glasses or watch cases, cases for portable telephone sets with or without integrated displays or all kinds of apparatuses and for CDs, DVDs, lenses for LEDs, optical waveguides, light couplers, light amplifiers, distributors and panes for lamps and laser alignment tools, multi-layer films, compound containers and all kinds of transparent composites.

2. Description of Prior Art

Because of their specific properties such as low weight, good chemical resistance and high mechanical stability, plastics have an increasing importance as a material, in particular also in materials composites. In addition, the excellent processability of thermoplastic plastics by injection moulding, casting, blow moulding, extrusion, etc. allows the manufacture of plastics articles and plastics moulded articles of any geometry, even complex work pieces or materials composites being easy to manufacture with a high precision.

Transparent or translucent thermoplastic plastics may be used in a number of fields of application such as automotive side windows, automotive headlamp diffuser, automotive sun roofs, aeroplane and touring caravan panes, building glazing, terrace and greenhouse roofing, covers for illuminated advertising systems, security glazing, commodities having a special decorative effect, lenses for corrective and sun-glasses, visors, transparent components for optical instruments and projection systems, contrast panes for monitors and television screens, optical fibres or photovoltaic cells. In many cases, however, the substitution for glass and other materials fails because of the intrinsic disadvantages of plastics.

But now transparent plastics moulding compounds, in particular transparent polyamide moulding compounds, are increasingly used in fields which have so far been reserved for high-purity glass or PMMA, PC or curable casting materials. The moulding compounds must not contain any particles or contaminants visible to the eye and must not produce any ones in any processing step either so that the moulded articles manufactured therefrom have a perfect purity and dyeability in lump or in the dipping bath. In the field of optical lenses which must be finished with hard coats to be scratch-proof, for example, special requirements for adhesion must be met. In many applications, the basic bodies of the moulded articles must be improved into composite materials and permanently bonded to other components by in-mould labelling, in-mould decoration, in-mould film decoration, composite injection moulding, laminating, vapour coating, printing, adhesive bonding, dyeing or coating, and sealing. In this case, above all, silicone-containing or liquid additives behave particularly disadvantageously.

Materials composites contain, for example, components of transparent plastics which are joined or bonded to decorative films, functional films such as polarizing films, hard-coat films, filter films, or coats or rubbers or other plastics.

Preferred applications are optical components such as ophthalmic lenses or sun lenses for eyeglasses, magnifier lenses, lens systems, microscopes, cameras, displays for portable telephone sets, camera lenses, measuring instruments, watch-glasses or watch cases, cases for portable telephone sets with or without integrated displays or all kinds of apparatuses. CDs, DVDs, lenses for LEDs, optical waveguides, light couplers, light amplifiers, distributors and panes for lamps and laser alignment tools, multi-layer films, compound containers and all kinds of transparent composites also require this quality and are in most cases improved with components which must adhere very well.

Apart from the perfect quality of the moulded article, stringent requirements must be met for birefringence, freedom from stress, coat adhesion, bonding adhesion, resistance to chemicals, toughness, alternate bending strength, bursting strength, temperature resistance, and weather resistance.

These properties are needed for filter cups in drinking-water pressure systems, in water meters, in bottles, hollow parts, pressure vessels, flow meters, eyeglasses, machine parts, level indicators, apparatus windows, and bulletproof or pressure-proof glazing, for example.

Ideal materials which incorporate the largest number of these properties in one product are transparent polyamides.

Over the last years, moulded articles made from transparent polyamides were improved in colour and transparency to achieve the quality level of moulded articles made from PMMA or PC moulding compounds. It has so far been possible to manufacture high-purity PMMA or PC moulded articles used for lenses, optical data storage media or optical waveguides from transparent polyamides only at higher reject rates, as the purity and the freedom from inclusions strongly depend on the processing method. The selection of the additives was substantially limited by the composites to be manufactured later.

The purity of transparent moulded articles is additionally affected adversely if, for example, lenses are to be manufactured which contain additives for UV protection and coloured pigments or other additives and accessory agents.

Deposits on screws and cylinder walls of injection moulding machines or in moulds having insufficiently venting capabilities have an adverse effect on the purity and quality of the moulded articles and require increased cleaning efforts.

It has therefore been a long-existing need to develop transparent plastics moulding compounds which allow moulded articles having a perfect purity and quality to be manufactured, the mould contour being exactly reproduced, while maintaining the above advantageous properties, in particular the excellent adhesion to the improvement components or surface layers, for the manufacture of stable materials composites. In addition, the rheological properties of the melt during forming are to be improved such that large flow lengths at low injection pressures become possible.

An important prerequisite for meeting the above requirements is the prevention of deposits on screws, cylinders, dies and within the moulds to efficiently extend cleaning intervals during production and to keep reject rates low.

The processing steps require excellent constant rheological properties, very small variations in dosing time and an excellent melting behaviour in the cylinder of the melting equipment.

The improvement of the rheological properties is generally done by setting lower viscosities in the polymer. The disadvantage thereof is a loss of mechanical properties such as toughness, bursting strength or alternate bending strength. Moreover, the resistance to chemicals such as the resistance to stress cracks in alcohols or acetone, for example, is also reduced, for example, in PC moulding compounds for the manufacture of CDs.

Similar effects are achieved if the glass-transition temperature of the amorphous polymer is adjusted to lower temperatures, in PMMA, for example, to 90-100° C. In this case, the disadvantage of a lower heat deflection temperature arises, which does not allow protective coats (such as Hardcoat for lenses) to be cured which is usually performed at 100 to 130° C.

Another way is the use of lubricants such as fatty acids, or metallic soaps such as stearic acid or palmitic acid, oleic acid, montanic acids or the calcium, magnesium or zinc salts thereof (DE 100 46 772 A1) which improve the processing behaviour and impact strength of ABS, for example. The adverse effect of silicone oils is pointed out in EP-A-0006521. These lubricants can substantially improve the processing behaviour, the distribution of additives and the rheological properties of transparent polyamides but they do not avoid sufficiently enough the formation of deposits on the screws or in the injection mould and they adversely affect the coat adhesion or the adhesion in composite injection-moulded parts in particular.

DE 199 26 622 A1 discloses the use of paraffin oil in combination with other lubricants in ABS/rubber materials which has advantages as to the rheological properties and impact strength But no details are given about a reduced formation of deposits and an improved purity of transparent moulded articles.

Paraffin oil is often used for preparing red phosphorus for the manufacture of flameproof polyamide moulding compounds, for example (WO 98/27153, EP-A-1024167), or as a softener in elastomer moulding compounds (DE-A-196 45 727). But these products do not exhibit any transparency.

WO 02/090421 A discloses thermoplastic polyamide moulding compounds based on copolyamides which contain diamines and dicarboxylic acids having aromatic nuclei which exhibit a high refractive index of >1.60 and a low density of less than 1.3 g/cm³. In addition, low birefringence and high hardness and scratch proofness are achieved. Manufacture is done in conventional pressure autoclaves by a modified process. Forming of the moulding compounds according to the invention is performed through thermoplastic processes. As compared with known materials such as PMMA or PC, optically relevant properties such as a high refractive index, hardness and heat deflection temperature were realized in one product. In addition to the advantageous combination of properties for optical applications, moulded articles made from the moulding compounds according to the invention have the excellent resistance to chemicals known for polyamides. For optical lenses, for example, a very low birefringence is desired to avoid the formation of coloured rings or distortions.

JP 58 033429 A, quoted as Abstract, discloses the manufacture of a plastics lens made of a radiation-curable base material such as PVC which can be coated with a reactive curable resin such as polystyrene.

WO 01/36524 A discloses polycarbonate compositions which exhibit an improved processability while maintaining very good mechanical properties of the moulded articles manufactured. The polycarbonate compositions contain an effective quantity of a lubricant of structures I, II and/or III, structure I being a diester of glycol with a mixture of monocarboxylic acids having 29 to 39 C-atoms. Structure II is a triester of glycerine, also with a mixture of monocarboxylic acids having 29 to 39 C-atoms. Structure III is a quadruple ester of pentaerythritol with a mixture of monocarboxylic acids having 16 to 18 C-atoms. In the same way as in Examples 1 to 7 of D3, lenses are made from these polycarbonate compositions and are coated with a polysiloxane-based hard coat on both sides.

EP-A-1,092,747 A discloses an additive composition for organic polymers and the use of the composition or of a single component of the composition as a lubricant for several transparent polymers such copolyamides, styrene copolymers, polycarbonates, polymethacrylates, transparent ABS, etc. It is intended that the use of the lubricants should enable transparent polymers to be produced without a limitation of the optical and mechanical properties. The polymer compositions can also be further processed and are also suited for coats.

In JP-A-50109247, polycarbonate/ABS blends (acrylonitrile/EP-rubber/styrene blends) are disclosed which contain 0.1 to 10% by weight of paraffin oil to improve low-temperature toughness. No details are given about the effect on the purity of a transparent moulded article and on the formation of deposits.

EP 1 092 747 B1 discloses additive compositions which separate materials and are lubricating, the use thereof, and a composition containing organic polymer based on saturated hydrocarbons selected from the group consisting of hexamethyltetracosanes and isomers thereof in combination with at least one polysiloxane polymer having a molecular weight over 500,000 g/mol. This additive composition of hexamethyltetracosane and polysiloxane polymer allows copolyesters such as PET, PBT, PEN and copolymers thereof, polyesters, polycarbonates, polyurethanes, polyacetals, polyamides, copolyamides, polyphenylene oxides, polyimides, polyamide imides, polysulphones, polyketones, polyamide compositions of high strength, transparent ABS, styrene resins, methacrylates, and polyether imides to be processed into moulded articles without producing deposits on the screw or in the mould. In some examples of EP 1 092 747 B1, 0.1% by weight of hexamethyltetracosane together with 0.1% by weight of polysiloxane polymer is used as an additive composition in the extrusion of HDPE. In other examples, PMMA copolymers, PET as well as styrene copolymers are processed together with the additive described.

Whether these advantages according to EP 1 092 747 B1 are sufficient to manufacture very demanding transparent moulded articles from defined transparent moulding compounds which are suited for applications in the field of lenses, CDs, DVDs, displays of portable telephone sets, camera lenses or optical waveguides, is not disclosed in detail in EP 1 092 747 B1 or is not apparent from the examples worked out there. Moreover, EP 1 092 747 B1 gives no suggestion at all, or does not allow any assessment to be made, as to whether optically disturbing particles over 35 μm in size remain in the moulded article anyway. In addition, no details are given about the cleaning cycles of lens manufacture, for example. With respect to the important adhesion to other materials in improved moulded articles or sheets, a person skilled in the art rather expects from EP 1 092 747 B1 disadvantages for the mobile, lubricating, peeling and liquefying additives.

### BRIEF SUMMARY OF THE NVENTION

It is therefore an object of the present invention to provide materials composites of a moulded article of transparent or translucent plastics moulding compounds which have transparent surface layers, etc., which exhibit a perfect purity and quality which have so far been achievable only with high-purity PMMA or polycarbonate materials and wherein the mould contour is exactly reproduced, while maintaining the above advantageous properties, in particular the excellent adhesion to the improvement components or surface layers, for the manufacture of stable materials composites. In addition, the rheological properties of the melt during forming are to be improved such that large flow lengths at low injection pressures become possible.

### BRIEF DESCRIPTION OF THE DRAWINGS

FIGS. 1 to 7 show the effect of the use of the lubricant (dodecanedioic acid) according to the present invention.

FIG. 1 shows the light transmittance of lenses (2 mm) measured with a BYK-Gardner haze meter, wherein the lens material was obtained according to references example 1, example 2, example 3, example 4 and example 5 (mixing polyamid material of the MACM12 type with 4% of Grilamid TR MB XE3805+UV400+lubricant (dodecanedioic acid). Especially haze was measured in FIG. 1.

FIG. 2 also shows the measurement of light transmittance of obtained lenses according to references example 1, example 2, example 3, example 4 and example 5. The lenses properties (clarity) were measured with a BYK-Gardner haze meter.

FIG. 3 again shows the transparency of the material according to references example 1, example 2, example 3, example 4 and example 5.

FIG. 4 shows the lens properties (2 mm) (haze) measured with a BYK-Gardner haze meter obtained from the compositions of references example 6, example 7, example 8 and example 9 of the present invention.

FIG. 5 shows the lens properties (2 mm) (clarity) measured with a BYK-Gardner haze meter obtained from the materials according to references example 6, example 7, example 8 and example 9 of the present invention.

FIG. 6 shows the transparency of the lenses obtained from the materials according to references example 6, example 7, example 8 and example 9 of the present invention.

FIG. 7 shows the transmission curves of the lenses of references example 14 and example 15 which coincident exactly. The material of the lenses (2 mm) were obtained according to the example 15 according to the present invention and to reference example 14.

### DETAILED DESCRIPTION OF THE INVENTION

The above object is solved by the materials composites of a moulded article of at least one transparent or translucent dyeable plastics moulding compound which moulded article is bonded to at least one transparent or translucent surface layer and/or to decorative films, functional films or coats or rubbers or other plastics, characterised in that said plastics moulding compound used for the manufacture of said moulded article, said surface layer or said other plastics contains in an amount of 0.01 to 5.0% by weight, preferably 0.01 to 2.0% by weight, each related to the total weight of the moulding compound, at least one lubricant selected from the group consisting of sorbitan esters, sebacic acid esters, dodecanedioic acid esters, docosanoic acid esters, glycerine, glycol, diethylene glycol, stearoyl amide, stearyl stearate, ethylene bissteroyl amide, octane pyrrolidone, and from the group consisting of non-polar paraffin oils and tetracosanes, and that a permanent adhesion to said other plastics layers and/or films or coats or rubbers or other plastics is achieved (cf. claim 1).

Preferred polyamide materials for use in the plastics moulding compounds for the manufacture of the moulded articles or materials composites according to the invention are defined by the following chains of formula (0):
—(NH—R₁—CO)ₓ—(NH—R₂—NH)_{y}—(CO—R₃—CO)_{y}— formula (0),
where

x, y stand for 0 to 100 mole-% and the groups R₁, R₂, R₃ may be the same or different and consist of linearly aliphatic or branched chains having 2-18 (CH₂) units or of chains having cycloaliphatic nuclei, dialkyl cycloaliphatic nuclei, alkylated cycloaliphatic nuclei, ortho, meta, para aromatic nuclei ortho, meta, para dialkyl aromatic nuclei or mixtures thereof, wherein the aromatic or cycloaliphatic nuclei may be mononuclear or polynuclear and may be bonded directly or indirectly or through linear or branched alkyl groups (cf. claim 14).

Further preferred polyamide materials according to the present invention are those consisting of:

A. 100 mole-% of a diamine mixture of 10-70 mole-% of PACM [bis-(4-amino-cyclohexyl) methane] containing less than 50% by weight of trans,trans isomers, and 90-30 mole-% of MACM [bis-(4-amino-3-methyl-cyclohexyl) methane], wherein 0-10 mole-% of the diamine mixture may be substituted by other aliphatic diamines having 6 to 12 C-atoms, cycloaliphatic, alkyl-substituted cycloaliphatic, branched aliphatic diamines or multiamines having 3 to 12 amino groups or mixtures thereof if required; and

B. 100 mole-% of long-chain aliphatic dicarboxylic acids having 8 to 14 C-atoms or mixtures of these dicarboxylic acids, wherein 0-10 mole-% of these dicarboxylic acids may be substituted by other aromatic or cycloaliphatic dicarboxylic acids having 8 to 16 C-atoms which are particularly selected from the group consisting of isophthalic acid, terephthalic acid, naphthaline dicarboxylic acid, cyclohexane dicarboxylic acid or mixtures thereof

wherein 0-100 mole-% of the other long-chain aliphatic diamines and 0-100 mole-% of the other long-chain aliphatic dicarboxylic acids may optionally be added as 0-20 mole-% of ω-amino acids having 6 to 12 C-atoms or lactams having 6 to 12 C-atoms (cf. claim 17).

In a preferred embodiment according to the invention said polyamides of said moulding compounds are polyamides based on copolyamides which particularly have a refractive index n_{D}²⁰ over 1.59, particularly preferably over 1.6, which have a predominant weight percentage of diamines and dicarboxylic acids having aromatic nuclei, characterised by the following chains represented by formula (A):
-{IPA-NH—R₁—NH}ₙ₁-{TPA-NH—R₂—NH}ₙ₂-{CO—R₃—NH)ₙ₃- (A),
where
n₁=40 to 100% by weight,
n₂=60 to 0% by weight,
n₃=0 to 30% by weight and wherein the weight percentages of n₁, n₂ and n₃ balance to 100% by weight,

wherein the diamines having the nuclei R₁, R₂ may be the same or different and consist of para-xylylene or meta-xylylene units in an amount of at least 30 mole-% related to 100 mole-% of diamine and consist of linearly aliphatic or branched chains having 2 to 12 (CH₂) units or of chains having cycloaliphatic nuclei which are used alone or as mixtures and wherein 100 mole-% of said dicarboxylic acids consist of at least 40 mole-% of isophthalic acid (IPA) and of terephthalic acid (TPA) in an amount to balance 100 mole-%, wherein said dicarboxylic acids may be substituted completely or partially by naphthaline dicarboxylic acids, wherein up to 30% by weight of said copolyamides of said moulding compounds may be substituted by amino acids or lactams having an R₃ nucleus, consisting of 5 to 11 (CH₂) chains (cf. claim 21).

In another embodiment of the invention said polyamides of said polyamide moulding compounds are polyblends consisting of

a polyamide having the composition of formula (I); and

at least one semicrystalline polyamide having the composition of formula (II), wherein the components of said polyamide (I) and said polyamide (II) are used in a ratio of 99:1 to 1:99, preferably 10:90 to 90:10, so that the sum equals 100 parts, wherein said polyamide (I) has the following monomer composition or is represented by chains of the following formulas (Ia) or (Ib): [symbol]
(—OOC—X—COO [symbol] ₐ [symbol] HN—H—NH [symbol] ₐ [symbol] OOC—Z—NH [symbol] _{b} [symbol] _{c} (Ia), [symbol]
(—OOC—X₁—COO)ₐ₁(HN—Y₁—NH)ₐ₁(OOC—Z₁—NH)_{b1}]_{c1} (Ib),
where
X=iso-phenylene, para-phenylene, 4-12 (CH₂) units, cyclohexyl, naphthyl, norbornyl, norbornane dimethyl, trimethyl hexamethylene,
X₁=iso-phenylene, para-phenylene, 2-12 (CH₂) units, cyclohexyl, naphthyl, norbornyl, norbornane dimethyl, trimethyl hexamethylene,
Y=(CH₂): 2-12 (CH₂) units, cyclohexyl, bis-(methyl-cyclohexyl) methane, bis-(methyl-cyclohexyl) ethane, bis-(methyl-cyclohexyl) propane, norbornyl, norbornane dimethyl, trimethyl hexamethylene, bis-(cyclohexyl) methane, bis-(cyclohexyl) ethane, bis-(cyclohexyl) propane,
Y₁=(CH₂): 2-12 (CH₂) units, cyclohexyl, bis-(methyl-cyclohexyl) methane, bis-(methyl-cyclohexyl) etbane, bis-(methyl-cyclohexyl) propane, norbornyl, norbornane dimethyl, trimethyl hexamethylene, bis-(cyclohexyl) methane, bis-(cyclohexyl) ethane, bis-(cyclohexyl) propane,
Z=(CH₂): 4-12 (CH₂) units, cyclohexyl, bis-(methyl-cyclohexyl) methane, bis-(methyl-cyclohexyl), bis-(methyl-cyclohexyl) ethane, bis-(methyl-cyclohexyl) propane, norbornyl, norbornyl dimethyl,
Z₁=(CH₂): 4-12 (CH₂) units, cyclohexyl, bis-(methyl-cyclohexyl) methane, bis-(methyl-cyclohexyl) ethane, bis-(methyl-cyclohexyl) propane, norbornyl, norbornyl dimethyl, trimethyl hexamethylene, and
a=0-50 mole-%, b=0-100 mole-%, a₁=0-50 mole-%, b₁=0-100 mole-%, and the sum of a+a₁+b+b₁ is 100 mole-% and the sum of c+c₁ is 100% by weight; and wherein said semicrystalline polyamide (II) is represented by chains of formula (IIa) and/or (IIb):
   [(—HN-u-COO—)_{d}(—HN-v-COO—)ₑ(—HN-s-NH—)_{f}(—OOC-t-COO—)_{f}]_{g} (IIa),
   [(—HN-s₁-NH—)_{f1}(—OOC-t₁-COO—)_{f1}]_{g1} (IIb),
   where
u=(CH₂): 4-12 (CH₂) units, v=(CH₂): 4-12 (CH₂) units,
s, s₁=(CH₂): 2-12 (CH₂) units, meta-xylylene, para-xylylene,
t, t₁=(CH₂): 2-12 (CH₂) units, iso-phenylene, para-phenylene,
f=0-50 mole-%, d=0-100 mole-%,
f₁=0-50 mole-%, e=0-100 mole-%,
wherein the sum of f+f₁+d+e is 100 mole-% and
the sum of g+g₁ is 100% by weight; and

at least 0.01 to 2.0 parts by weight of a phosphorus compound of formula (III), related to 100 parts by weight of said polyamides of formulas (Ia)/(Ib), (IIa)/(IIb), which may be used in a pure form or as an aqueous solution:
[X(R′)ₙP(O)₁(OR′)ₘ] (III),
where
X═H, —OR″, 2-pyridyl, —NH₂, —NHR′, —NR′R″, wherein X may be bonded to (R′) or may be directly bonded to P,
R′=(CH₂)ₙ₁, linear or branched,
R″=Li, Na, K, H, (CH₂)ₙ₂, linear or branched, and
n=integer of 0 to 5; 1=0, 1, 1.5, 2, 2.5; m=integer of 0 to 3; n₁=integer of 1 to 12, n₂=1 to 12; and/or

0.01 to 15 parts by weight of cyclic phosphonic acid anhydride compounds of formula (IV), related to 100 parts by weight of said polyamides of formulas (Ia)/(Ib), (IIa)/(IIb), which may be used in a pure form or as an aqueous solution:
[—(R)PO(O)—]ₙ (IV),
where
n=3, 4, 5, 6, an alternating —P—O— heterocycle having 3, 4, 5, 6 (P—O) units in the ring,

R=CH₃, C₂H₅, C₃H₇, C₄H₉, isobutyl, 2,2,6,6-tetramethyl-4-piperidyl (cf. claim 25).

The other subclaims include advantageous embodiments of the invention.

Surprisingly, the above object is solved by the use of lubricants selected from the group consisting of sorbitan esters, sebacic acid esters, dodecanedioic acid esters, docosanoic acid esters, glycerine, glycol, diethylene glycol, stearoyl amide, stearyl stearate, ethylene bissteroyl amide, octane pyrrolidone, and particularly preferably by lubricants selected from the group consisting of non-polar paraffin oils which do not adversely affect the adhesion to hard coats on optical lenses, for example.

A particularly suited glass-clear, colourless paraffin oil (HTNP) contains (by GC analysis) the main components 2,6,10,15,19,23-hexamethyltetracosane including several low-molecular paraffins. The Si content is below 100 ppm. This paraffin oil composition is a glass-clear liquid which has a melting point of −40° C. and a density of 0.810 to 0.830 g/ml and is completely insoluble in water. Relevant products which are liquid in the range from 40° C. to 240° C. (10 mm Hg) are on the market.

According to the invention, these lubricants develop a positive effect during the extrusion or injection moulding processing process if they are rolled with or without pigments onto the granulate, compounded with the base polymer as a pure additive or in the form of a master batch and/or are melt-filtered or are already added to the base polymer during polymerisation or polycondensation.

The plastics moulding compounds for the manufacture of the moulded article and/or the transparent surface layer and/or the other plastics of the materials composite according to the invention may be selected from the group consisting of plastics made of polymethyl methacrylate, polycarbonate, diethylene-glycol-diallyl carbonate (CR 39), polystyrene, polyethylene terephthalate, polybutylene terephthalate, PEN, and the copolymers thereof, polyamide, copolyamide, polyether sulphone, poly(aryl) ether ketone, polyimide, polyurethane, polyacetal, polyamide imide, polyether ketone, polyether imide, polyphenylene oxide, poly(oxymethylene), acrylonitrile/butadiene/styrene polymer.

The moulded articles of the materials composite according to the invention may be manufactured by the injection moulding process or injection compression moulding process, injection blow moulding process, injection stretch blow moulding process or extrusion process or a special injection moulding process.

The materials composites according to the invention are particularly improved by in-mould labelling, in-mould decoration, in-mould film decoration, composite injection moulding, laminating, vapour coating, printing, adhesive bonding, dyeing or coating, and sealing and are permanently bonded to other components.

The material composites according to the present invention may be coated, and it is particularly preferred that they are coated, and it is particularly preferred that hard coats or dyeable hard coats are attached with or without a primer-coat layer from solution onto the moulded article manufactured by thermoplastic forming processes or by forming processes for reactive casting compounds such as polyurethane casting compounds, and that they are cured.

In a preferred embodiment, vapour coating processes (sputtering) are used to apply layers to these moulded articles or composites, a silicon hard coat or shade being produced by evaporation of metals with or without a preparation by plasma treatment.

The materials composites according to the invention are used for optical components such as ophthalmic lenses or sun lenses for eyeglasses, magnifier lenses, lens systems, microscopes, cameras, displays for mobile cellular telephones, camera lenses, measuring instruments, watch-glasses or watch cases, cases for portable telephone sets with or without integrated displays or all kinds of apparatuses and for CDs, DVDs, lenses for LEDs, optical waveguides, light couplers, light amplifiers, distributors and panes for lamps and laser alignment tools, multi-layer films, compound containers and all kinds of transparent composites.

The plastics moulding compounds used for the manufacture of the moulded articles according to the invention are, in a preferred embodiment, polyamide moulding compounds. The polyamide moulding compounds contain transparent or translucent polyamides according to formula (0) below.

The polyamide compositions for the polyamide moulding compounds may consist of one or more components of the polyamides of formula (0) (see above) and one or more components of semicrystalline polyamides, copolyamides or block copolyamides. In this case, the components of semicrystalline polyamides, copolyamides or block copolyamides may be partially or completely substituted by foreign polymers, or the components of semicrystalline polyamides, copolyamides or block copolyamides may contain other polymers selected from the group consisting of impact strength modifiers such as grafted sheath/core polymers, impact strength modifiers such as SBR, SBS, EPS, EPR, SEBS, EMP, EPDM, maleic anhydride, grafted polyethylenes, propylene, terpolymers of ethylene-glycidyl methacrylate or from the group consisting of thermotropic or thermochromic additives which change the shade in dependence on temperature or independent of the wavelength of the radiated light The compositions may also contain other processing agents or reinforcing materials such as glass fibres or balls, or antidamping agents.

In the moulding compounds according to the invention, isorefractive grafted sheath/core polymers and isorefractive reinforcing materials are particularly preferred Suitable transparent polyamides consist of lactams, amino acids and/or dicarboxylic acids containing appropriate quantities of diamines, the skeletons of the respective monomers originating from the group of aliphatics, cycloaliphatics or aromatics which may comprise other substitutes or branches.

Moreover, transparent polyamides of semicrystalline polyamides and/or semicrystalline copolyamides with amorphous polyamides and/or amorphous copolyamides may be manufactured as polymer blends or alloys by compounding in single-screw or multiple-screw extruders at temperatures between 200 and 350° C.

The transparent polyamides of suitable monomer combinations are manufactured, for example, by the well-known polycondensation processes in pressure autoclaves up to 40 bar. Modified processes up to a maximum of 6 bar are employed if activated diamines having aromatic nuclei are used. Optionally, the synthesizing step may be influenced through elimination of the reaction water by applying vacuum. The manufacture may also be performed in two steps, precondensates being produced first which are then brought to the desired final viscosity in a melt postcondensation process in extruders, for example.

The polymer melts thus obtained are pelletized by well-known continuous granulators or apparatuses for hot severing. Preferably, the polymer melt is cleaned by continuous or discontinuous melt filtration using screens having a mesh size of 5 to 100 μm, or sand filters or filter cartridges made of ceramic or metallic sintered materials before it is pelletized. These pellets are adjusted to the desired humidity, i. e. a water content of 0.01 to 0.1%, in dryers at temperatures of 60 to 180° C. using dry gases such as air or nitrogen or in a vacuum of 1 to 1000 mbar.

Compositions for transparent polyamides result from formula (0):
—(NH—R₁—CO)ₓ—(NH—R₂—NH)_{y}—(CO—R₃—CO)_{y}— (0),
where
x, y: 0 to 100 mole-%,
R₁, R₂, R₃: linear or branched chains having 2-18 (CH₂) units; cycloaliphatics; dialkyl cycloaliphatics; alkylated cycloaliphatics; o/m/p-aromatics; o/m/p-dialkyl aromatics or mixtures thereof. The aromatics or cycloaliphatics may be mononuclear or polynuclear and may be bonded directly or through linear or branched alkyl groups.

Compositions for transparent polyamide blends result from one or more components of formula (0) and one or more components of semicrystalline polyamides, copolyamides or block copolyamides or other semicrystalline plastics such as sheath/core polymers.

Preferred compositions for transparent polyamides, without aromatics, are moulding compounds consisting of 100 mole-% of a diamine mixture of 0-100 mole-% of PACM [bis-(4-amino-cyclohexyl) methane] and 0-100 mole-% of MACM [bis-(4-amino-3-methyl-cyclohexyl) methane], wherein 0-10 mole-% of the diamine mixture, may be substituted by other diamines such as aliphatic diamines having 6 to 12 C-atoms, cycloaliphatic, alkyl-substituted cycloaliphatic, branched aliphatic diamines or multiamines having 3 to 12 amino groups or mixtures thereof and wherein 0-100 mole-% of these dicarboxylic acids or mixtures thereof may be substituted by 100 mole-% of long-chain aliphatic dicarboxylic acids or mixtures of these dicarboxylic acids having 8 to 14 C-atoms, wherein cyclohexane dicarboxylic acid or mixtures thereof are preferred (cf. claim 17).

The 0-10 mole-% of the other diamines and the 0-10 mole-% of the other dicarboxylic acids may be optionally added as 0-20 mole-% of amino acids or lactams.

Preferred are transparent moulding compounds made from 100 mole-% of a diamine mixture of 30-70 mole-% of bis-(4-amino-cyclohexyl) methane containing less than 50% by weight of trans,trans isomers and 70-30 mole-% of bis-(4-amino-3-methyl-cyclohexyl) methane, and from 100 mole-% of dodecanedioic acid or sebacic acid or azelaic acid or mixtures thereof.

Particularly preferred are transparent moulding compounds made from 100 mole-% of a diamine mixture of 40-70 mole-% of bis-(4-amino-cyclohexyl) methane containing less than 50% by weight of trans,trans isomers and 60-30 mole-% of bis-(4-amino-3-methyl-cyclohexyl) methane, and from 100 mole-% of dodecanedioic acid.

Particularly preferred are transparent moulding compounds made from 100 mole-% of a diamine mixture of 50-70 mole-% of bis-(4-amino-cyclohexyl) methane containing less than 50% by weight of trans,trans isomers and 50-30 mole-% of bis-(4-amino-3-methyl-cyclohexyl) methane, and from 100 mole-% of dodecanedioic acid.

Particularly preferred are transparent moulding compounds made from 100 mole-% of a diamine mixture of 50-70 mole-% of bis-(4-amino-cyclohexyl) methane containing less than 50% by weight of trans,trans isomers of the Dicykan type by the trade name of 4,4′-diaminodicyclohexyl methane (CAS No. 1761-71-3, made by BASF) and 50-30 mole-% of bis-(4-amino-3-methyl-cyclohexyl) methane of the Laromin C260 type by the trade name of 3,3′-dimethyl4,4′-diaminodicyclohexyl methane (CAS No. 6864-37-5, made by BASF), and from 100 mole-% of dodecanedioic acid.

To adjust the desired relative viscosity, measured in a 0.5% m-cresol solution, of 1.65 to 2.00, preferably 1.70 to 1.95, either the diamine or the dicarboxylic acids may be used in an appropriate excess. Preferred is the adjustment by monoamine or monocarboxylic acids of 0.01 to 2.0% by weight, preferably 0.05 to 0.5% by weight.

Suitable adjusting agents are benzoic acid, acetic acid, propionic acid, stearylamine or mixtures thereof. Particularly preferred are adjusting agents having ammo or carboxylic acid groups which contain stabilizing agent groups of the HALS (hindered amine light stabiliser) type or tertiary butyl phenol type such as triacetone diamine or the isophthalic acid-di-triacetone diamine derivative.

Suitable catalysts for the acceleration of the polycondensation reaction are phosphorus-containing acids such as H₃PO₂, H₃PO₃, H₃PO₄, the salts or organic derivatives thereof, which also lead to a reduction of the discoloration during processing, in the range of 0.01 to 0.5% by weight, preferably 0.03 to 0.1% by weight.

Suitable defoaming agents to avoid foaming during venting are aqueous emulsions containing silicones or silicone derivatives, in the range of 0.01 to 1.0% by weight, preferably 0.01 to 0.10% by weight, for a 10% emulsion.

Suitable heat or UV stabilisers may be added to the formulation in an amount of 0.01 to 0.5% by weight before polycondensation. Preferably, high-melting types are used, Irganox 1098 or Nylostab-SEED, Tinuvin 770, Tinuvin 320, Tinuvin 326, Tinuvin 327 being particularly preferred.

The manufacture of the moulding compound according to the invention is performed in well-known pressure autoclaves. First, a compression phase is run at 260-310° C. Then an expansion is performed at 260-310° C. Venting is also performed at 260-310° C. Subsequently, the moulding compound is discharged as an extrudate, is cooled in a water bath of 5-80° C. and is then granulated. The granulate is dried for 12 hours at 80° C. to a water content below 0.06%.

During the drying process in which the granulate is also circulated, additives such as lubricants, colorants, stabilisers or others may be applied or sintered onto the granulate.

Preferred transparent or translucent dyeable polyamide moulding compounds having aromatics contain aromatic dicarboxylic acids such as isophthalic acid, terephthalic acid or naphthalene dicarboxylic acid alone or as a mixture, whereas isophthalic acid forms the largest fraction. Of course, the relevant esters or other substituted derivatives may also be used. Specific selection of different symmetric or asymmetric isomers of naphthaline dicarboxylic acid allows the crystallization behaviour to be influenced. A part of the aromatic dicarboxylic acids may be substituted by aliphatic dicarboxylic acids.

Suitable diamines preferably contain aromatic nuclei such as meta-xylene diamine or para-xylene diamine, or they originate from the group of aromatic diamines or substituted aromatic diamines, and they may be used alone or as a mixture. A smaller part of the aromatic diamines may be substituted by aliphatic or cycloaliphatic diamines.

The preferred transparent or translucent dyed polyamide moulding compound having a refractive index over 1.59, preferably over 1.6, contains a predominant weight percentage of diamines and dicarboxylic acids having aromatic nuclei of formula (A):
—{IPA—NH—R₁—NH}ₙ₁{TPA—NH—R₂—NH}ₙ₂—{CO—R₃—NH)ₙ₃— (A),
where
n₁=40 to 100% by weight,
n₂=60 to 0% by weight,
n₃=0 to 30% by weight and wherein the weight percentages of n₁, n₂ and n₃ balance to 100% by weight,
   wherein the diamines having the nuclei R₁, R₂ may be the same or different and consist of para-xylylene or meta-xylylene units and may consist of linearly aliphatic or branched chains of 2 to 12 (CH₂) units or of chains having cycloaliphatic nuclei which are used alone or as mixtures (cf. claim 21).

100 mole-% of the dicarboxylic acids consist of at least 40 mole-% of isophthalic acid (IPA) and of terephthalic acid (TPA) in an amount to balance 100 mole-%, wherein TPA may completely or partially be substituted by naphthaline dicarboxylic acids .

Up to 30% by weight of the moulding compound may be substituted by amino acids or lactams having an R₃ nucleus which consist of 5 to 11 (CH₂) nuclei

Preferred is a composition of formula (B):
MXDI/MXDT/6I/6T (B),
where
meta-xylylene diamine (MXD): 20 to 100 mole-%,
hexamethylene diamine (6): 80 to 0 mole-%,
isophthalic acid (1): 50 to 100 mole-%, and
terephthalic acid (T): 50 to 100 mole-%,
   each related to 100 mole-% of diamine and 100 mole-% of dicarboxylic acids, wherein meta xylylene may completely or partially be substituted by para- xylylene diamine, and wherein terephthalic acid may completely or partially be substituted by naphthaline dicarboxylic acid, wherein symmetric or asymmetric isomers or mixtures thereof may be used (cf. claim 22). Preferred are asymmetric isomers.

Particularly preferred is a composition of formula (B):
MXDI/MXDT/6I/6T (B),
where
meta-xylylene diamine (MXD): 20 to 80 mole-%,
hexamethylene diamine (6): 80 to 20 mole-%,
isophthalic acid (1): 60 to 80 mole-%, and
terephthalic acid (T): 40 to 20 mole-%,
   each related to 100 mole-% of diamine and 100 mole-% of dicarboxylic acids.

Particularly preferred is a composition of formula (C):
6I/6T/6NDC (C),
where
naphthaline dicarboxylic acid (NDC) having a symmetric or asymmetric substituent position or mixtures thereof: 20 to 80 mole-%,
isophthalic acid (1): 80 to 20 mole-%,
terephthalic acid (T): 40 to 0 mole-%, and
hexamethylene diamine (6): 100 mole-%, which hexamethylene diamine may completely or partially be substituted by ethylene diamine, trimethyl hexamethylene diamine, or linear diamines having 8 to 12 CH₂-groups, or cycloaliphatic diamines such as norbornane diamine, 4,4′-diaminodicyclohexyl methane, 3,3′-dimethyl4,4′-diaminodicyclohexyl methane or mixtures thereof each related to 100 mole-% of diamine and 100 mole-% of dicarboxylic acids.

Suitable diamines having aromatic nuclei are meta-xylylene diamine and para-xylylene diamine, for example.

Suitable aliphatic diamines or aliphatic dicarboxylic acids are those having 2 to 12 CH₂-units which may be unbranched or branched.

Suitable cycloaliphatic diamines or cycloaliphatic dicarboxylic acids contain skeletons such as norbornyl methane, cyclohexyl methane, dicyclohexyl methane, dicyclohexyl propane, di(methyl-cyclohexyl)methane, di(methyl-cyclohexyl)propane.

Suitable dicarboxylic acids having aromatic nuclei are isophthalic acid (IPA), terephthalic acid (TPA), naphthaline dicarboxylic acid having several symmetric and asymmetric isomers, and mixtures thereof which are used as acids or their esters and mixtures thereof.

To accelerate the reaction during polycondensation, suitable phosphorus-containing catalysts such as H₃PO₂, H₃PO₃, H₃PO₄ may be added to the aqueous formulation in an amount of 0.01 to 0.2% by weight.

To stabilise the colour for polymerisation and later processing, phosphorus-containing stabilisers of the R₃PO₂, R₃PO₃, R₃PO₄ type in the form of acids with R═H or which have organic linear or cyclic groups may be used in an amount of 0.01 to 0.2% by weight, or stabilisers containing sterically hindered phenols may be used in an amount of 0.01 to 0.2% by weight.

To adjust the chain length, either monofunctional amines or monofunctional acids are polymerised, or an excess of diamine or dicarboxylic acid is used. Particularly preferred are types of adjusting agents having stabiliser functions, such as polysubstituted piperidinyl groups and tertiary-butyl phenyl groups.

The plastics moulding compounds according to the invention may contain additives such as UV absorbers which filter out UV light below 400 nm, for example, or colouring substances for shading lenses, or thermotropic or thermochromic additives which are temperature-dependent or which change the shade in dependence on the wavelength of the radiated light, or isorefractive grafted sheath/core polymers for a high impact resistance, or lubricants and other processing agents or isorefrative reinforcing materials such as glass fibres or balls, or antidamping agents.

The plastics moulding compound according to the invention is manufactured by a well-known condensation process in pressure autoclaves, the special feature of which is that no process step in the tank exceeds a pressure of 4 bar. At higher pressures, these diamines having aromatic nuclei tend to form branches which drastically increase the melt viscosity at 260° C., for example, and hence make the discharge from the reactors impossible.

Suitable processes for working in desired additives such as UV absorbers which filter out UV light below 400 nm, for example, or colouring substances for shading lenses, or phototropic, thermotropic or thermochromic additives which change the shade in dependence on temperature or on the wavelength of the radiated light, or isorefractive grafted sheath/core polymers for a high impact resistance are the well-known compounding processes in extruders.

Suitable processes for forming the granulate into one-component lenses are all the processes known for thermoplastics, in particular injection moulding in multi-cavity moulds.

Moreover, the moulding compounds according to the invention allow the manufacture of composite lenses from in-mould decorated sheets or other moulded articles which lenses have polarisation properties or are finished with UV absorbers which filter out UV light below 400 nm, for example, or with colouring substances for shading lenses, or with phototropic, thermotropic or thermochromic additives which change the shade in dependence on temperature or on the wavelength of the radiated light. Moreover, composite lenses may be manufactured by in-mould decorating protective films with the lens material whereby the resistance to chemicals or the mechanical stressability or the sliding or abrasion behaviour can be improved Suitable applications for the high-refractive moulding compounds according to the invention are optical lenses for eyeglasses, cameras, binoculars, microscopes, electrooptical measuring and test instruments, optical filters, headlight lenses, lamp lenses, projectors and beamers, observation windows and sight glasses.

To finish the surfaces, well-known processes such as coating with a hard coat, soft coat or UV protective coat, vapour coating with carbon or with metal atoms, plasma treatment and grafting of layers may be used.

These moulding compounds according to the invention may of course be used as blend components in other amorphous or semicrystalline polyamides and may be finished with the conventional reinforcing materials, nano particles, impact strength modifiers, colouring substances, flame-retardant, softeners, stabilisers, and lubricants.

Preferred transparent polyamide blends comprise a polyamide (I) having the composition of formula Ia/Ib, and at least one semicrystalline polyamide (II) having the composition of formula IIa/IIb. The components polyamide (I) and polyamide (II) are used in a ratio of 99:1 to 1:99, preferably 10:90 to 90:10, so that the sum equals 100 parts (cf. claim 25).

As another component, at least one phosphorus compound of formula (III) in an amount of 0.01 to 2 parts related to 100 parts of polyamides, or of formula (IV) in an amount of 0.01 to 15 parts related to 100 parts of polyamides is added, whereby a flame-retardant effect is also achieved. The phosphorus compounds of formula (III) and formula (IV) may of course be used as mixtures.

Optionally, one or more usual stabilisers may be added in an amount of 0 to 2 parts related to 100 parts of polyamides.

Of course, fillers, reinforcing materials, flame-retardant, softeners, lubricants, colouring substances, processing agents and other well-known finishing agents may be added.

Polyamide (I) contains the monomer composition of formulas (Ia) and (Ib): [symbol]
(—OOC—X—COO [symbol] ₐ [symbol] HN—H—NH [symbol] ₐ [symbol] OOC—Z—NH [symbol] _{b} [symbol] _{c} (Ia),
and [symbol]
(—OOC—X₁—COO)ₐ₁(HN—Y₁—NH)ₐ₁(OOC—Z₁—NH)_{b1}]_{c1} (Ib),
where
X=iso-phenylene, para-phenylene, 4-12 (CH₂) units, cyclohexyl, naphthyl, norbornyl, trimethyl hexamethylene,
X₁=iso-phenylene, para-phenylene, 2-12 (CH₂) units, cyclohexyl, naphthyl, norbornyl, trimethyl hexamethylene,
Y=(CH₂): 2-12 (CH₂) units, cyclohexyl, bis-(methyl-cyclohexyl) methane/ethane/propane, norbornyl, trimethyl hexamethylene, bis-(cyclohexyl) methane/ethane/propane,
Y₁=(CH₂): 2-12 (CH₂) units, cyclohexyl, bis-(methyl-cyclohexyl) methane/ethane/propane, norbornyl, trimethyl hexamethylene, bis-(cyclohexyl) methane/ethane/propane,
Z=(CH₂): 4-12 (CH₂) units, cyclohexyl, bis-(methyl-cyclohexyl) methane/ethane/propane, norbornyl,
Z₁=(CH₂): 4-12 (CH₂) units, cyclohexyl, bis-(methyl-cyclohexyl) methane/ethane/propane, norbornyl, and
a=0-50 mole-%, b=0-100 mole-%,
a₁=0-50 mole-%, b₁=0-100 mole-%.

The sum of a+a₁+b+b₁ is 100 mole-%. The sum of c+c₁ is 100% by weight.

Semicrystalline polyamide (II) contains the monomer composition of formula (II):
[(—HN-u-COO—)_{d}(—HN-v-COO—)ₑ(—HN-s-NH—)_{f}(—OOC-t-COO—)_{f}]_{g} (IIa),
[(—HN-s₁-NH—)_{f1}(—OOC-t₁-COO—)_{f1}]_{g1} (IIb),
where
u=(CH₂): 4-12 (CH₂) units, v=(CH₂): 4-12 (CH₂) units,
s, s₁=(CH₂): 2-12 (CH₂) units, meta-xylylene, para-xylylene,
t, t₁=(CH₂): 2-12 (CH₂) units, iso-phenylene, para-phenylene,
f=0-50 mole-%, d=0-100 mole-%,
f₁=0-50 mole-%, e=0-100 mole-%,

The sum of f+f₁+d+e is 100 mole-%.

The sum of g+g₁ is 100% by weight.

Phosphorus compounds of formula (III) may be added in a pure form or as an aqueous solution.
[X(R′)ₙP(O)₁(OR″)ₘ] (III),
where
X═H, —OR″, 2-pyridyl, —NH₂, —NHR′, —NR′R″, wherein X may be bonded to (R′) or may be directly bonded to P,
R′=(CH₂)ₙ₁, linear or branched,
R″=Li, Na, K, H, (CH₂)ₙ₂, linear or branched, and
n=0 to 5; 1=0, 1, 1.5, 2, 2.5; m=0 to 3; n₁1 to 12, n₂=1 to 12.

Cyclic phosphonic acid anhydride compounds of formula (IV) may also be added in a pure form or as an aqueous solution.
[—(R)PO(O)—]ₐ (IV),
where
n=3, 4, 5, 6, an alternating —P—O— heterocycle having 3, 4, 5, 6 (P—O) units in the ring,
R=CH₃, C₂H₅, C₃H₇, C₄H₉, isobutyl, 2,2,6,6-tetramethyl-4-piperidyl.

Of course, mixtures of the phosphorus compounds may also be used.

Suitable manufacturing methods for the polyamide blends according to the invention are all the well-known extrusion processes if extrusion temperatures with resulting compound temperatures between 250 and 330° C. are used.

Suitable processing methods for the polyamide blends according to the invention are thermoplastic processing methods by which moulded articles, films, plates, fibres, tubes and pipes, and bars are manufactured at temperatures of 200 to 350° C.

Suitable applications for moulded articles, films, plates, fibres, tubes and pipes, bars, and coatings made of the polyamide blends according to the invention are eyeglasses, cameras, lenses, lighting systems, mirrors, panes, sight glasses, optical components, instrument panels, bottles, containers, medical-, cosmetic- and hygiene-articles, toothbrushes, handles, packagings, costume jewellery, laminations, multilayer films, coextrusion films, plate-like semi-finished products, cylindrical semi-finished products, optical waveguides, optical fibres, cable sheathings, tubes, pipes, and lines, or protective coatings, varnishes and insulating materials for wires which are made from solution, grids/grilles, baskets, sheet metals, magnetic coils, deflection coils.

The manufacture of the plastics or polyamide moulding compounds according to the invention by finishing with the lubricants according to the invention may be performed in three ways:
a) Mixing the liquid containg the lubricant with the granulate;
b) Producing a master-batch granulate and producing a granulate mixture;
c) Adding the lubricant before or during the polymerisation or polycondensation.

The moulding compounds according to the invention may additionally contain a UV protective agent which reduces in 2 mm lenses the light transmission of wavelengths below 400 nm which are harmful to the eye to less than 0.5%.

Suitable UV absorbers are hydroxyphenyl benzotriazoles or hydroxyphenyl chlorobenzotriazoles such as tinuvines, uvinols or others.

The addition of the UV absorbers may be done by mixing with the granulate of the moulding compound according to the invention or by adding as a separately manufactured master batch in the form of a granulate which was manufactured by extrusion of the moulding compounds according to the invention, which have an increased concentration of the UV absorber, on extruders in the form of a granulate.

Alternatively, the lubricants according to the invention may be worked into this UV master batch. As a base material for the UV master batch, transparent polyamide moulding compounds which differ from the moulding compound according to the invention but do not cause any severe haze may also be used.

The manufacture of the moulding compound according to the invention is particularly advantageous if all additives are worked in in one step in the extruder and are present as a homogeneous granulate.

These moulding compounds according to the invention are processed in the next step on an injection moulding machine such as the Allrounder 270° C. 500-100 type made by Arburg (clamping force: 500 kN).

Typical setting parameters for processing the moulding compounds of the Reference Examples or Examples 1-35 are as follows:

| | |
|---|---|
| Cylinder temperature: | 260, 265, 270, 270, 270° C. |
| | (special high settings, hopper to |
| | nozzle) |
| Mould temperature: | 80° C. |
| Circumferential speed of the screw: | 15 m/min (special high setting) |
| Specific back pressure: | 50 bar |
| Injection speed: | 15 cm³/sec |
| Injection volume: | 20 cm³ (max. 47 cm³ = 43%) |
| Switch-over point to holding pressure: | 3 cm³ |

Using a highly polished mould having 1 cavity in the mould of a lens, plane-parallel, 2 mm in thickness, relevant test lenses were made from the moulding compound according to the invention. The lens quality was tested for purity, haze, clarity, and light transmission.

In a sealing-up process the moulding compound according to the invention was tested for processability in a 4-cavity mould. When lenses had been manufactured over several days, the mould was tested for deposits and the runtime was determined after which the screw had to be cleaned.

The lenses from the scaling-up process were tested for the property of light transmission using a Perkin-Elmer type UV spectrometer.

The crucial property of adhesion was tested on a standard-coat system which was applied by conventional processes to improve scratch proofness and was tested for its adhesion to the lens. To this end, cross cuts were applied before and after UV ageing and after storage in cooking water and were assessed.

Particularly preferred are hard coats made by SDC Coating Inc. such as TC 1179 or dyeable hard coats such as TC-3000 which are attached with or without a primer-coat layer, such as the primer coat PR 1165, from solution onto the moulded article manufactured by thermoplastic forming processes or by forming processes for reactive casting compounds such as polyurethane casting compounds, and which are cured.

Particularly preferred are vapour coating processes (sputtering) to apply layers to these moulded articles where a silicon hard layer or a shade, for example, is produced by evaporation of metals with or without a preparation by plasma treatment.

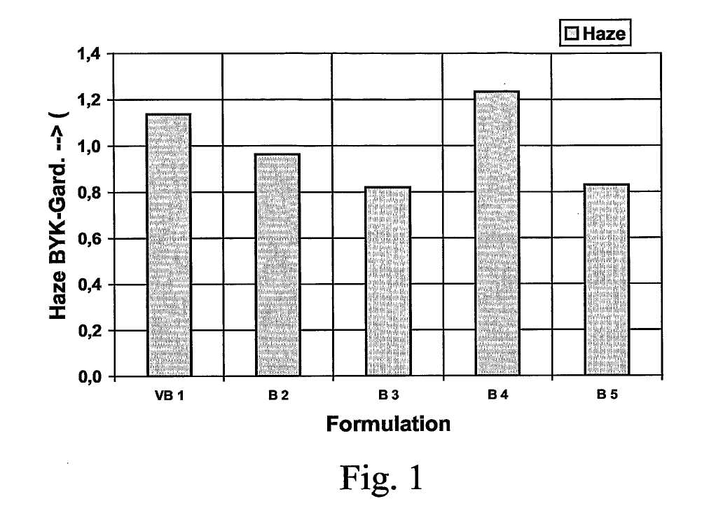

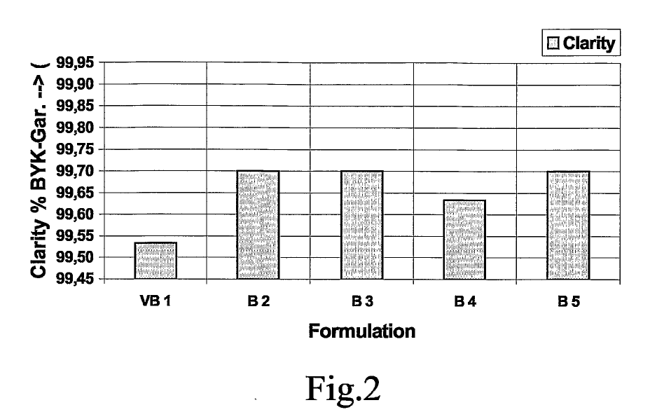

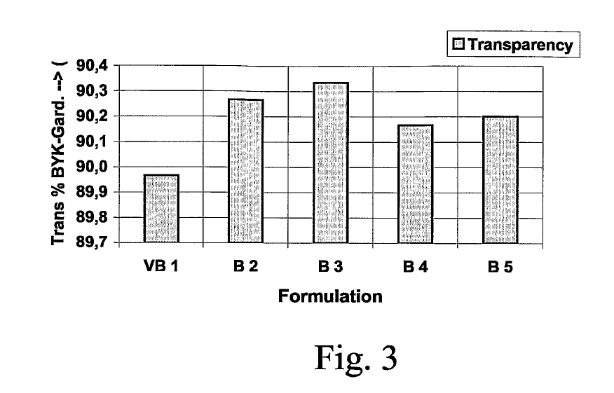

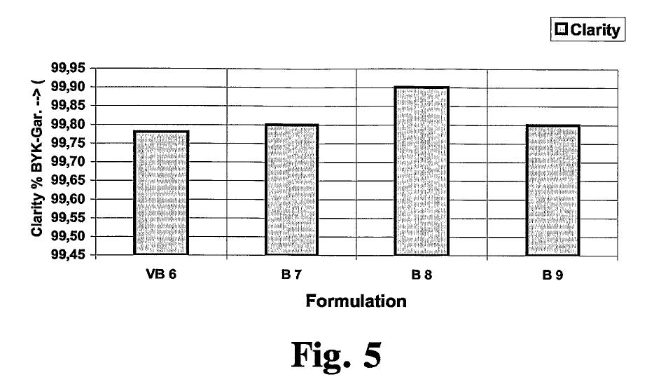

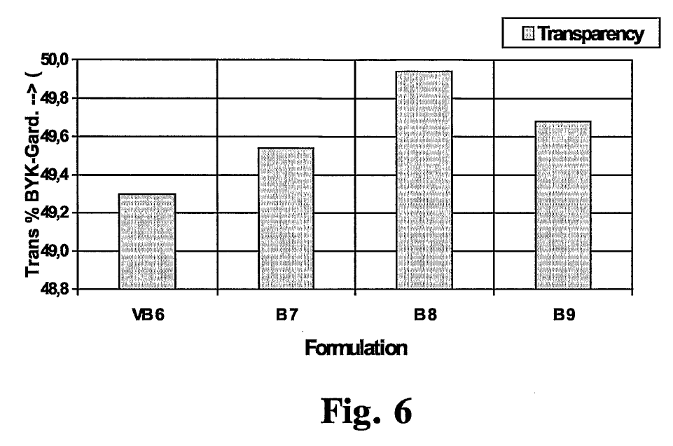

The invention will now be described in detail by way of the following Examples by referring to FIGS. 1 to 7 and Tables 1 to 4 but without limiting the invention thereto.

The abbreviations and materials used in the Examples are given below.

### EXAMPLES

### Reference Examle 1

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates and the mixture was extruded on a two-screw extruder (WP ZSK30, 280° C.), was cut into a granulate and was dried to a humidity below 0.06%.

This granulate was processed into plane-parallel lenses of 75 mm in diameter and 2 mm in thickness on an injection moulding machine. The lenses were measured by radiating light onto the convex side. UV absorption was below 99.8% up to 400 nm.

Light transmittance was 89.9%. The lens properties obtained were measured with a Byk-Gardner haze meter (FIGS. 1-3).

### Examples 2, 3 And 5 (According To the Invention): Reference Example 4

Several lubricants were admixed to the granulate mixture of Example 1 which was then extruded, was cut into a granulate, was dried to a humidity below 0.06% and was processed into test lenses in the same way. In Examples 2-5, UV protection was 99.8% up to 400 nm.

| | |
|---|---|
| Example 2: | +0.05% of paraffin oil (HTNP) (liquid); |
| Example 3: | +0.10% of paraffin oil (HTNP) (liquid); |
| Reference Example 4: | +0.10% of calcium stearate (CS) (powder); |
| Example 5: | +0.10% of saturated poly(oxyethylene)-sorbitan |
| | fatty acid ester (liquid), type: Polysorbat 20 |
| | (PS20). |

The comparison of the optical properties (FIGS. 1-3) shows that the liquid lubricants exhibit the lowest haze values (in %), the highest clarity (in %) and markedly increased transmission values (in %, by the Byk-Gardner method). With respect to transparency, the paraffin oil HTNP (0.1%) shows the highest value of 90.3%). The powdery calcium stearate exhibits the highest haze of 1.2%.

### Reference example 6

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates and the mixture was extruded on a two-screw extruder (WP ZSK30, 280° C.), was cut into a granulate was dried to a humidity below 0.06% and was mixed with orange pigments.

This mixture was processed into plane-parallel lenses of 75 mm in diameter and 2 mm in thickness on an injection moulding machine. The lenses were measured by radiating light onto the convex side. UV protection was 99.8% up to 400 nm.

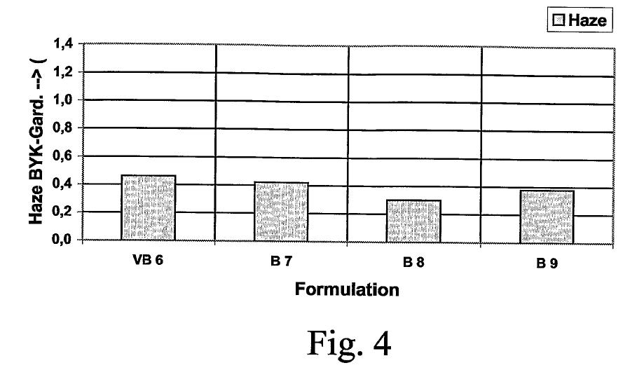

Light transmittance was 49.3%. The lens properties obtained were measured with a Byk-Gardner haze meter (FIGS. 4-6).

### Examples 7 And 8 (According To the Invention): Reference Example 9

Several lubricants were admixed to the granulate mixture of Example 1 which was then processed into test lenses in the same way. In Examples 7-9, UV protection was 99.8% up to 400 nm.

| | |
|---|---|
| Example 7: | +0.05% of paraffin oil (HTNP) (liquid); |
| Example 8: | +0.10% of paraffin oil (HTNP) (liquid); |
| Reference Example 9: | +0.10% of calcium stearate (KS) (powder). |

The comparison of the optical properties (FIGS. 4-6) shows that the liquid lubricant HTNP exhibits the lowest haze values (in %), the highest clarity (in %) and markedly increased transmission values (in %, by the Byk-Gardner method). HINP produces a clearly better distribution of the powdery coloured pigment.

### Reference Example 10

Highly transparent polyamide of the MACM12 type, a trading item of EMS Chemie AG, which has a Tg of 155° C. and a relative viscosity of 1.73 (0.5% m-cresol) was processed on an injection moulding machine into plane-parallel lenses of 75 mm in diameter and 2 mm in thickness. A 4-cavity mould having cavities arranged in the form of a star and a cold runner was used.

The production time required to detect black particles in the lenses which indicate the formation of a deposit on the plastication unit in the injection moulding machine was determined. The results are summarized in Table 1.

### Example 11 (According To the Invention)

Highly transparent polyamide of the MACM12 type, a trading item of EMS Chemie AG, which has a Tg of 155° C. and a relative viscosity of 1.73 (0.5% m-cresol) was mixed with 0.05 % of HTNP in the form of granulates.

This mixture was processed on an injection moulding machine into plane-parallel lenses of 75 mm in diameter and 2 mm in thickness. A 4-cavity mould having cavities arranged in the form of a star and a cold runner was used.

The production time required to detect black particles in the lenses which indicate the formation of a deposit on the plastification unit in the injection moulding machine was determined. The results are summarized in Table 1.

### Reference Example 12

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates.

This mixture was processed on an injection moulding machine into plane-parallel lenses of 75 mm in diameter and 2 mm in thickness. A 4-cavity mould having cavities arranged in the form of a star and a cold runner was used.

The production time required to detect deposits in the cavities of the lens mould was determined. The results are summarized in Table 1.

### Example 13 (According To the Invention)

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates.

This mixture was processed on an injection moulding machine into plane-parallel lenses of 75 mm in diameter and 2 mm in thickness. A 4-cavity mould having cavities arranged in the form of a star and a cold runner was used.

The production time required to detect deposits in the cavities of the lens mould was determined. The results are summarized in Table 1.

### Reference Example 14

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates and with brown pigment in an amount of 0.1%.

This mixture was processed on an injection moulding machine into plane-parallel lenses of 75 mm in diameter and 2 mm in thickness. A 4-cavity mould having cavities arranged in the form of a star and a cold runner was used.

The production time required to detect deposits in the cavities of the lens mould was determined. The results are summarized in Table 1.

### Example 15 (According To the Invention)

Highly transparent polyamide of the MACM12 type which has a Tg of 155° C. and a relative viscosity of 1.73 (0.5% m-cresol) was mixed with 4% of Grilamid TR MB XE3805 UV400, both being trading items of EMS Chemie AG, in the form of granulates and with HTNP in an amount of 0.05% and brown pigment in an amount of 0.1%.

This mixture was processed on an injection moulding machine into plane-parallel lenses of 75 mm in diameter and 2 mm in thickness. A 4-cavity mould having cavities arranged in the form of a star and a cold runner was used.

The production time required to detect deposits in the cavities of the lens mould was determined. The results are summarized in Table 1.

Coating of the lenses is performed in dipping bathes by conventional methods for lens coating. Two systems of SDC Coating Inc. were tested: a) Hardcoat TC 1179 and b) primer coat Primer PR 1165 +Hardcoat HC 1179. The lenses were cleaned in distilled water in an ultrasonic bath (23° C.) and were air-dried for 20 minutes. The cleaned lens was immersed in the primer coat bath (23° C.), was drawn out at 25 cm/min and was air-dried for 20 minutes. To apply the hard coat (HC), the lens was immersed in the HC bath (23° C.), was drawn out at 30 cm/min and was air-dried for 20 minutes. Curing was performed in an oven at 115° C. for 2 hours. Subsequently, the coated lenses were subjected to cross-cut tests before and after ageing.

To this end, horizontal and vertical lines were cut into the coat at a distance of 1 mm each (e. g. 5×5 lines) so that coat squares of 1 mm² in area were produced. This grid was taped with a transparent tape (e. g. Sellotape). After the transparent tape had been stripped off, the number of the detached coat squares was counted. Adhesion is given as a ratio (%) of the non-detached coat squares to the total number of coat squares.

TABLE 1

| | Ref. Ex. | | Ref. Ex. | | Ref. Ex. | |
|---|---|---|---|---|---|---|
| | 10 | Ex. 11 | 12 | Ex. 13 | 14 | Ex. 15 |
| HTNP, % | 0 | 0.05 | 0 | 0.05 | 0 | 0.05 |
| Grilamid, % | 0 | 0 | 4 | 4 | 4 | 4 |
| Coloured pigment, % | 0 | 0 | 0 | 0 | 0.1 | 0.1 |
| Screw deposit, hrs | 72 | >168 | — | — | — | — |
| Mould deposit, hrs | | | 0.5 | 4.0 | 3.0 | 4.5 |
| Process stability | medium | good | medium | good | poor | good |
| Coat adhesion | | | | | | |
| SDC/HC-1179 | | | | | | |
| Bayer Abrassion | 350 | | | | | |
| Cross cut, original | 100% | 100% | 100% | 100% | 100% | 100% |
| Water, 100° C./1 hr | 100% | 100% | 100% | 100% | 100% | 100% |
| UV ageing/5 days | 60% | 60% | 60% | 60% | 60% | 60% |
| UV ageing/appearance | small | small | small | small | small | small |
| | cracks | cracks | cracks | cracks | cracks | cracks |
| SDC/Primer 1165/HC-1179 | | | | | | |
| Bayer Abrassion | 417 | | | | | |
| Cross cut, original | 100% | 100% | 100% | 100% | 100% | 100% |
| Water, 100° C./1 hr | 100% | 100% | 100% | 100% | 100% | 100% |
| UV ageing/5 days | 100% | 100% | 100% | 100% | 100% | 100% |
| UV ageing/appearance | OK | OK | OK | OK | OK | OK |

By adding HTNP, the intervals until screw deposits are produced may be clearly extended. The intervals until mould deposits are produced are also extended so that the economic efficiency of the process is clearly improved and the entire process runs much more stably.

The expected negative effects on the adhesion of the hard coat do not occur even after UV ageing of the composite in an “Atlas Suntester CPS”. The cross-cut test does not reveal any disadvantages for adhesion even if 0.1% of HTNP was added to the moulding compound.

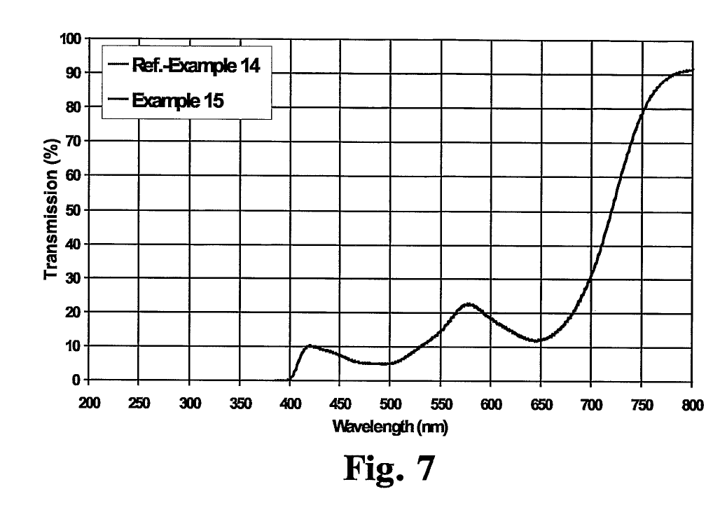

The sensitive properties of light transmission and UV protection as well as the colour effect remain unchanged (FIG. 7). The transmission curves of the lenses of Reference Example 14 and Example 15 coincide exactly.

### Reference Example 16

36.1 g of MACM and 34.5 g of dodecanedioic acid were mixed in 30 g of water in a stirrer vessel and were heated with agitation without pressure up to the respective boiling point so that a temperature of 280° C. was gradually reached. Subsequently, the mixture was degassed with agitation at 280° C. for circa 2 hours until the desired torque was reached. Then the transparent polyamide melt obtained was cooled down, was ground and was dried to a moisture content below 0.06%. The data obtained for the material are summarized in Table 2.

### Examples 17-19 (According To the Invention)

36.1 g of MACM, 34.5 g of dodecanedioic acid and varying amounts of HTNP were mixed in 30 g of water in a stirrer vessel and were heated with agitation without pressure up to the respective boiling point so that a temperature of 280° C. was gradually reached. Subsequently, the mixture was degassed with agitation at 280° C. for circa 2 hours until the desired torque was reached. Then the transparent polyamide melt obtained was cooled down, was ground and was dried to a moisture content below 0.06%. The data obtained for the materials are summarized in Table 2.

TABLE 2

| | Ref. Ex. | | | |
|---|---|---|---|---|
| | 16 | Ex. 17 | Ex. 18 | Ex. 19 |
| HTNP, % | 0 | 0.01 | 0.05 | 0.10 |
| Relative viscosity, 0.5% m-cresol | 1.611 | 1.734 | 1.678 | 1.646 |
| Torque of stirrer, % | 250 | 330 | 250 | 240 |
| Condensation time (hrs) | 2.4 | 2.0 | 2.0 | 2.0 |
| Glass-transition temperature | 150 | 152 | 150 | 150 |
| Tg, ° C. | | | | |
| Visual colour | good | good | good | good |

The Examples show that in the manufacture of the moulding compound according to the invention, the liquid HTNP can be added directly to the formulation without interfering with the polycondensation process. The visible quantity-dependent effect on the viscosity can be compensated for by adjusting the amount of the chain transfer agent The condensation time is advantageously reduced by adding HTNP.

### Reference Example 20

A cycloaliphatic polyamide, manufactured by conventional methods, of the MACM12 type [bis-(4-amino-3-methyl-cyclohexyl) methane made by BASF: Laromin C 260 and dodecanedioic acid] which has a relative viscosity of 1.73 (0.5% of m-cresol) and a Tg of 155° C. was tested for flowability on an Arburg injection moulding machine having a compound temperature of 280° C. and a mould temperature of 60° C. The flow channel in the mould was 1.5 mm in diameter and 10 mm in width and was spirally arranged. The flow length was measured in mm at 1000 bar. Yellow index and light transmission were measured on plates of 60 mm×50 mm×3 mm. The melt flow rate (MVR) was measured at 275° C./5 kg.

### Example 21 (According To the Invention)

In the same way as in Reference Example 20, the cycloaliphatic polyamide was mixed with a master batch consisting of 90% of cycloaliphatic polyamide and 10% of calcium stearate.

### Example 22 (According To the Invention)

In the same way as in Reference Example 20, the cycloaliphatic polyamide was mixed with a master batch consisting of 90% of Polyamid 12 having a relative viscosity of 1.6 (0.5% of m-cresol) and 10% of calcium stearate.

### Example 23 (According To the Invention)

In the same way as in Reference Example 20, the cycloaliphatic polyamide was mixed with a master batch consisting of 90% of Polyamid 12 having a relative viscosity of 1.6 (0.5% of m-cresol) and 10% of HTNP.

### Reference Example 24

In the same way as in Reference Example 20, a blend of 75% of the cycloaliphatic polyamide and of Polyamid 12 having a relative viscosity of 2.5 was used

### Examples 25 To 27 (According To the Invention)

The polyamide blend of Example 24 was mixed with the respective master batches in the same way as in Examples 21 to 23.

TABLE 3

| | REx. 20 | Ex. 21 | Ex. 22 | Ex. 23 | REx. 24 | Ex. 25 | Ex. 26 | Ex. 27 |
|---|---|---|---|---|---|---|---|---|
| MACM12, % | 100 | 90 | 90 | 90 | 75 | 67.5 | 67.5 | 67.5 |
| PA12, % | | | | | 25 | 22.5 | 22.5 | 22.5 |
| Master batch, % | | 10 | 10 | 10 | | 10 | 10 | 10 |
| Flow length, mm | 180 | 193 | 190 | 212 | 205 | 225 | 225 | 232 |
| Yellow index | 2.9 | 2.6 | 2.0 | 1.5 | 5.0 | 4.3 | 4.3 | 3.7 |
| Transmission, %, | 89 | 89 | 89 | 90 | 87 | 86 | 86 | 87 |
| 560 nm | | | | | | | | |
| Melt flow rate, | 29 | 37 | 38 | 40 | 42 | 59 | 59 | 59 |
| cm³/10 min | | | | | | | | |

The matrix in the examples of Table 3 consists of PAMACM12 or a PAMACM12/PA12 blend. Of the different lubricants in the respective master batches, the lubricants of Examples 23 and 27 exhibit the best behaviour in terms of flow length and melt flow rate without adversely affecting the transparency. Moreover, they effect a slight reduction in yellow index.

### Reference Examples 28 and 32

According to the Reference Examples 20 and 24, an aromatic copolyamide of the MACMI/12 type having a relative viscosity of 1.55 and a Tg of 160° C. was used. The mould temperature was increased to 80° C.

### Examples 29 To 31 And 33 To 35 (According To the Invention)

The polyamide blend of Example 28 was mixed with the respective master batches in the same way as in Examples 21 to 23. The mould temperature was increased to 80° C.

TABLE 4

| | REx. 28 | Ex. 29 | Ex. 30 | Ex. 31 | REx. 32 | Ex. 33 | Ex. 34 | Ex. 35 |
|---|---|---|---|---|---|---|---|---|
| MACMI/12, % | 100 | 90 | 90 | 90 | 75 | 67.5 | 67.5 | 67.5 |
| PA12, % | | | | | 25 | 22.5 | 22.5 | 22.5 |
| Master batch, % | | 10 | 10 | 10 | | 10 | 10 | 10 |
| Flow length, mm | 165 | 175 | 175 | 182 | 240 | 250 | 250 | 270 |
| Yellow index | 3.1 | 2.2 | 2.2 | 2.2 | 8 | 10 | 10 | 10 |
| Transmission, %, | 86 | 86 | 87 | 87 | 86 | 86 | 86 | 86 |
| 560 nm | | | | | | | | |
| Melt flow rate, | 20 | 24 | 22 | 28 | 54 | 71 | 69 | 76 |
| cm³/10 min | | | | | | | | |

The matrix in the examples of Table 4 consists of CoPAMACMI/12 or a CoPAMACMI/12/PA12 blend. Of the different lubricants in the respective master batches, the lubricants of Examples 31 and 35 exhibit the best behaviour in terms of flow length and melt flow rate without adversely affecting transparency.

### Reference Example 36

A cycloaliphatic polyamide, manufactured by conventional methods, of the MACM12 type [bis-(4-amino-3-methyl-cyclohexyl) methane made by BASF: Laromin C 260 and dodecanedioic acid] having a relative viscosity of 1.73 (0.5% of m-cresol) and a Tg of 155° C. was tested for its ejection behaviour on an Arburg injection moulding machine.

To this end, a slightly conical cup having a centre gate was manufactured and the ejection force during discharge was measured. The cup had the following dimensions:

| | |
|---|---|
| Diameter at the bottom: | 57 mm |
| Diameter at the opening: | 58 mm |
| Height: | 94 mm |
| Wall thickness: | 3.5 mm |

The following parameters were used for processing:

| | |
|---|---|
| Cylinder temperature, zone 4: | 255° C. |
| Cylinder temperature, zone 3: | 260° C. |
| Cylinder temperature, zone 2: | 265° C. |
| Die temperature: | 260° C. |
| Mould temperature: | 80° C. |
| Circumferential speed of screw: | 9.4 m/min |
| Specific back pressure: | 100 bar |
| Injection speed: | 40 mm/sec |
| Holding pressure/holding pressure time: | 600 bar/8 sec |
| | 400 bar/6 sec |
| | 200 bar/6 sec |
| Cycle time: | 59 sec |

### Reference Example 37

In the same way as in Reference Example 36, the cycloaliphatic polyamide was mixed with a master batch consisting of 90% of aromatic copolyamide of the MACMI/12 type which has a relative viscosity of 1.55 and a Tg of 160° C., and 10% of calcium stearate.

### Reference Example 38

In the same way as in Reference Example 36, the cycloaliphatic polyamide was mixed with a master batch consisting of 90% of cycloaliphatic polyamide and 10% of calcium stearate.

### Example 39 (According To the Invention)

In the same way as in Reference Example 36, the cycloaliphatic polyamide was mixed with a master batch consisting of 90% of cycloaliphatic polyamide and 10% of HTNP.

The ejection forces measured in Reference Examples 36-38 and in Example 39 according to the invention are given in Table 5.

### Reference Example 40

An aromatic copolyamide, manufactured by conventional methods, of the MACMI/12 type [bis-(4-amino-3-methyl-cyclohexyl) methane made by BASF: Laromin C 260, isophthalic acid and Lactam 12] having a relative viscosity of 1.55 (0.5% of m-cresol) and a Tg of 160° C. was tested for its ejection behaviour on an Arburg injection moulding machine in the same way as in Reference Example 37.

### Reference Example 41

In the same way as in Reference Example 40, the cycloaliphatic polyamide was mixed with a master batch consisting of 90% of aromatic copolyamide of the MACMI/12 type which has a relative viscosity of 1.55 and a Tg of 160° C., and 10% of calcium stearate.

### Reference Example 42

In the same way as in Reference Example 40, the cycloaliphatic polyamide was mixed with a master batch consisting of 90% of cycloaliphatic polyamide and 10% of calcium stearate.

### Example 43 (According To the Invention)

In the same way as in Reference Example 40, the cycloaliphatic polyamide was mixed with a master batch consisting of 90% of cycloaliphatic polyamide and 10% of HTNP.

The ejection forces measured in Reference Examples 40-42 and in Example 43 according to the invention are given in Table 5.

TABLE 5

| | REx. 36 | REx. 37 | REx. 38 | Ex. 39 | REx. 40 | REx. 41 | REx. 42 | Ex. 43 |
|---|---|---|---|---|---|---|---|---|
| MACM12, % | 100 | 96 | 96 | 96 | 0 | 0 | 0 | 0 |
| MACMI/12, % | 0 | 0 | 0 | 0 | 100 | 96 | 96 | 96 |
| Master batch, % | 0 | 4 | 4 | 4 | 0 | 4 | 4 | 4 |
| Ejection force, N | 5710 | 2840 | 2510 | 2308 | 3585 | 2672 | 2483 | 1690 |

The matrix in the examples of Table 5 consists of PAMACM12 or an aromatic copolyamide of the MACMI/12 type. Of the different lubricants in the respective master batches, the lubricants of Examples 39 and 43 exhibit the best behaviour in terms of ejection force.

It goes without saying that the above results of the present invention can also be applied to the materials PMMA and PC without any problem.

List of the abbreviations used

| | |
|---|---|
| AA | azelaic acid |
| AES | acrylonitrile/EP rubber/styrene |
| Bayer Abrassion | method of measurement |
| Byk-Gardner | method of measurement |
| CD | compact disk |
| CoPA | copolyamide |
| CS | calcium stearate |
| DDA | dodecanedioic acid |
| DVD | digital versatile disk |
| Ex. | example according to the invention |
| ex AWT | application development department |
| GM | lubricant |
| HALS | hindered amine light stabiliser |
| HC | hard coat |
| hr, hrs | hour, hours |
| HTNP | hexamethyltetracosane including low-molecular |
| | paraffin |
| I | isophthalic acid |
| IPA | isophthalic acid |
| LED | light-emitting diode |
| m- | meta |
| MACM | bis-(4-amino-3-methyl-cyclohexyl) methane |
| MB | master batch |
| MVR | melt flow rate |
| MXD | meta-xylylene diamine |
| NDC | naphthaline dicarboxylic acid |
| o- | ortho |
| p- | para |
| PA | polyamide |
| PACM | bis-(4-amino-cyclohexyl) methane |
| PC | polycarbonate |
| PMMA | polymethyl methacrylate |
| Ref. Ex. | Reference Example |
| REx. | Reference Example |
| RV | relative viscosity |
| SA | sebacic acid |
| T | terephthalic acid |
| Tg | glass-transition temperature |
| TPA | terephthalic acid |
| UV | ultraviolet |
| YI | yellow index |

Materials used in the examples

| | |
|---|---|
| Brown pigment | |
| Calcium | |
| stearate | |
| CoPA | Copolyamide of MACM, IPA and Lactam 12 which has |
| MACMI/12 | a relative viscosity of 1.55 and a Tg of 160° C. |
| DDA | Dodecanedioic acid |
| Grilamid | UV master batch based on a transparent polyamide, a |
| TR MB | trading item of EMS-Chemie AG |
| XE3805 | |
| UV400 | |
| Hardcoat | Trading item of SDC Coating Incontinence. |
| TC 1179 | |
| HTNP | Trading item of Polychem, Versapol GP-446 |
| MACM | Trading item of BASF, Laromin C260 |
| Orange | |
| pigment | |
| PA12 | Homopolyamide of Lactam 12 which has an RV of 2.5 |
| PAMACM12 | Homopolyamide of MACM and DDA |
| Paraffin oil | Trading item of Polychem, Versapol GP-446 |
| HTNP | |
| Polyamid 12 | Homopolyamide of Lactam 12 which has an RV of 2.5 |
| Polysorbat 20 | |
| Primer PR | Trading item of SDC Coating Inc. |
| 1165 | |
| % data given | Per cent by weight as far as formulation components are |
| in the | concerned |
| Examples | |
| XE3805 | Homopolyamide of MACM and DDA which has an RV |
| | of 1.73 and a Tg of 155° C. |

1-26. (canceled)

27. Material composites of a moulded article of at least one transparent or translucent dyeable plastic moulding compound which moulded article is bonded to at least one transparent or translucent surface layer, decorative films, functional films or coats or rubbers or other plastics, characterised in that said plastics moulding compound used for the manufacture of said moulded article, said surface layer or said other plastics contains in an amount of 0.01 to 5.0% by weight, preferably 0.01 to 2.0% by weight, each related to the total weight of the moulding compound, at least one lubricant selected from the group consisting of sorbitan esters, sebacic acid esters, dodecanedioic acid esters, docosanoic acid esters, glycerine, glycol, diethylene glycol, stearoyl amide, stearyl stearate, ethylene bissteroyl amide, octane pyrrolidone, and from the group consisting of non-polar paraffin oils and tetracosanes, and that a permanent adhesion to said other plastics layers and/or films or coats or rubbers or other plastics is achieved.

28. The material composites according to claim 1, wherein said lubricant contains at least one hydrocarbon having a tetracosane basic structure, and low-molecular paraffins.

29. The material composites according to claim 2, wherein said tetracosane used is a 2,6,10,15,19,23-hexamethylene tetracosane and/or isomer thereof.

30. The material composites according to claim 1, wherein said moulding compound for the manufacture of said moulded article and/or said transparent surface layers and/or said other plastics comprises polymethyl methacrylate, polycarbonate, diethylene-glycoldiallyl carbonate (CR 39), polystyrene, polyethylene terephthalate, polybutylene terephthalate, PEN, and copolymers thereof, polyamide, copolyamide, polyether sulphone, poly(aryl) ether ketone, polyimide, polyurethane, polyacetal, polyamide imide, polyether ketone, polyether imide, polyphenylene oxide, poly(xymethylene), acrylonitrile/butadiene/styrene polymer or mixtures thereof.

31. The material composites according to claim 1, wherein said at least one lubricant is added during the polymerisation or polycondensation of said plastics moulding compounds, is included by a process selected from the group consisting of compounding as a master batch, is applied to the granulate made nom said plastics moulding compounds and is used for the dispersion of coloured pigments.

32. The material composites according to claim 1, wherein said transparent or translucent dyeable plastic moulding compounds for the manufacture of said moulded article and/or for the manufacture of said transparent or translucent surface layer are polyamide moulding compounds selected from the group consisting of lactams, ω-amino acids and/or dicarboxylic acids including suitable amounts of diamines, the structures of the respective monomers being derived nom the group of aliphatics, cycloaliphatics or aromatics which may comprise other substituents or branches.

33. The material composites according to claim 1, wherein said moulded articles are manufactured by the methods of the group consisting of injection moulding process, injection compression moulding process, injection blow moulding process, injection stretch blow moulding process or extrusion process, film-laminating process and a special injection moulding process.

34. The material composites according to claim 1, further comprising in-mould labelling, in-mould decoration, in-mould film decoration, composite injection moulding, laminating, vapour coating, printing, adhesive bonding, dyeing or coating, and sealing and are permanently bonded to other components.

35. The material composites according to claim 8, wherein said composites are coated, hardcoated or dyeable hard coated and are attached with or without a primer-coat layer from solution onto the moulded article manufactured by thermoplastic forming processes or by forming processes for reactive casting compounds such as polyurethane casting compounds, and subsequently cured.

36. The material composites according to claim 8, wherein vapour coating processes (sputtering) are used to apply layers to said moulded articles wherein a silicon hard coat or a shade is produced by evaporation of metals with or without a preparation by plasma treatment.

37. The material composites according to claim 8, used for optical components such as ophthalmic lenses or sun lenses for eyeglasses, magnifier lenses, lens systems, microscopes, cameras, displays for mobile cellular telephones, camera lenses, measuring instruments, watch-glasses or watch cases; cases for portable telephone sets with or without integrated displays or all kinds of apparatuses and for CDs, DVDs, lenses for LEDs, optical waveguides, light couplers, light amplifiers, distributors and panes for lamps and laser alignment tools, multi-layer films, compound containers and all kinds of transparent composites.

38. The material composites according to claim 8, wherein said coats applied comprise a colouring substance and/or an antireflection coating and/or a UV protection and/or photochromic and/or thermochromic and/or antifogging and/or water-repellent and/or scratch-proof functions.

39. The material composites according to claim 1, wherein said other plastics are made of transparent plastics containing lubricants and are joined or bonded to decorative films, functional films such as polarizing sheets, hard-coat films, filter films, or coats or rubbers or other plastics.

40. The material composites according to claim 4, wherein said polyamides of said moulding compounds are represented by the following chains of formula (0):
—(NH—R₁—CO)ₓ—(NH—R₂—NH)_{y}—(CO—R₃—CO)_{y}— formula (0),
wherein
x, y stand for up to 100 mole-% and the groups R₁, R₂, R₃ may be the same or different and consist of linearly aliphatic or branched chains having 2-18 (CH₂) units, chains having cycloaliphatic nuclei, dialkyl cycloaliphatic nuclei, alkylated cycloaliphatic nuclei, ortho, meta, para aromatic nuclei, ortho, meta, para dialkyl aromatic nuclei or mixtures thereof, wherein the aromatic or cycloaliphatic nuclei may be mononuclear or polynuclear and may be bonded directly or indirectly or through linear or branched alkyl groups.

41. The material composites according to claim 14, wherein said polyamide compositions for said polyamide moulding compounds consist of one or more components of said polyamides of formula (0) and one or more components of semicrystalline polyamides, copolyamides, or block copolyamides.

42. The material composites according to claim 14, wherein said polyamide compositions for said polyamide moulding compounds consist of one or more components of said polyamides of formula (0) and one or more components selected from the group consisting of impact strength modifiers such as grafted sheath/core polymers, impact strength modifiers such as SBR, SBS, EPS, EPR, SEBS, EMP, EPDM, maleic anhydride, grafted polyethylenes, propylene, terpolymers of ethylene-glycidyl methacrylate, and from the group of foreign polymers or from the group of thermotropic or thermochromic additives which change the shade in dependence on temperature or independent of the wavelength of the radiated light, and other processing agents or from the group of reinforcing materials such as glass fibres or balls, or antidamping agents.

43. The material composites according to claim 14 wherein said polyamides of said moulding compounds consist of:
A. 100 mole-% of a diamine mixture of 10-70 mole-% of PACM [bis-(4-aminocyclohexyl) methane] containing less than 50% by weight of trans,trans isomers, and 90-30 mole-% of MACM [bis-(4-amino-3-methyl-cyclohexyl) methane], wherein 0 -10 mole-% of the diamine mixture. may be substituted by other aliphatic diamines having 6 to 12 C-atoms, cycloaliphatic, alkyl-substituted cycloaliphatic, branched aliphatic diamines or multiamines having 3 to 12 amino groups or mixtures thereof; and
B. 100 mole-% of long-chain aliphatic dicarboxylic acids having 8 to 14 C-atoms or mixtures of these dicarboxylic acids, wherein 0-100 mole-% of these dicarboxylic acids may be substituted by other aromatic or cycloaliphatic dicarboxylic acids having 8 to 16 C-atoms which are particularly selected from the group consisting of isophthalic acid, terephthalic acid, naphthaline dicarboxylic acid, cyclohexane dicarboxylic acid or mixtures thereof, wherein up to 100 mole-% of the other long-chain aliphatic diamines and up to 100 mole-% of the other long-chain aliphatic dicarboxylic acids may optionally be added as up to 20 mole-% of ω-amino acids having 6 to 12 C-atoms or lactams having 6 to 12 C-atoms.

44. The material composites according to claim 17, wherein said polyamides consist of:
C. 100 mole-% of a diamine mixture of 30-70 mole-% of PACM [bis-(4-aminocyclohexyl) methane] containing less than 50% by weight of trans,trans isomers, and 70-30 mole-% of MACM [bis-(4-amino-3-methyl-cyclohexyl) methane]; and
D. 100 mole-% of dodecanedioic acid (DDA) or sebacic acid (SA) or azelaic acid (AA) or mixtures thereof.

45. The material composites according to claim 18, wherein said polyamides consist of
E. 100 mole-% of a diamine mixture of 40-70 mole-% of PACM [bis-(4-aminocyclohexyl) methane] containing less than 50% by weight of trans,trans isomers, and 60-30 mole-% of MACM [bis-(4-amino-3-methyl-cyclohexyl) methane]; and
F. 100 mole-% of dodecanedioic acid.

46. The material composites according to claim 19, wherein said polyamides consist of:
G. 100 mole-% of a diamine mixture of 50-70 mole-% of PACM [bis-(4-aminocyclohexyl) methane] containing less than 50% by weight of trans,trans isomers, and 50-30 mole-% of MACM [bis-(4-amino-3-methyl-cyclohexyl) methane]; and
H. 100 mole-% of dodecanedioic acid.

47. The material composites according to claim 1, wherein said polyamides of said moulding compounds are polyamides based on copolyamides which particularly have a refractive index n_{D}²⁰ over 1.59, which have a predominant weight percentage of diamines and dicarboxylic acids having aromatic nuclei, characterised by the following chains represented by formula (A):
—{IPA—NH—R₁—NH}ₙ₁—{TPA—NH—R₂—NH}ₙ₂—{CO—R₃—NH)ₙ₃— (A),
where
n₁=40 to 100% by weight,
n₂=60 to 0% by weight,
n₃=0 to 30% by weight and wherein the weight percentages of n₁, n₂ and n₃ balance to 100% by weight,
wherein the diamines having the nuclei R₁, R₂ may be the same or different and consist of paraxylylene or meta-xylylene units in an amount of at least 30 mole-% related to 100 mole-% of diamine and consist of linearly aliphatic or branched chains having 2 to 12 (CH₂) units or of chains having cycloaliphatic nuclei which are used alone or as mixtures and wherein 100 mole-% of said dicarboxylic acids consist of at least 40 mole-% of isophthalic acid (IPA) and of terephthalic acid (TPA) in an amount to balance 100 mole-%, wherein TPA may completely or partially be substituted by naphthaline dicarboxylic acids, wherein up to 30% by weight of said copolyamides of said moulding compounds may be substituted by amino acids or lactams having an R₃ nucleus, consisting of 5 to 11 (CH₂) chains.

48. The material composites according to claim 21, wherein said copolyamides comprise the composition of formula (B):
MXDI/MXDT/6I/6T (B),
where
the respective components have the following mole percentages:
meta-xylylene diamine (MXD): 20 to 100 mole-%,
hexamethylene diamine (6): 80 to 0 mole-%,
isophthalic acid (I): 50 to 100 mole-%, and
terephthalic acid (T): 50 to 100 mole-%,
each related to 100 mole-% of diamine and 100 mole-% of dicarboxylic acids, wherein meta-xylylene diamine may completely or partially be substituted by para-xylylene diamine and wherein terephthalic acid may completely or partially be substituted by naphthaline dicarboxylic acid, wherein symmetric or preferably asymmetric isomers or mixtures thereof may be used

49. The material composites according to claim 22, wherein said copolyamides comprise the composition of formula (B):
MXDI/MXDT/6I/6T (B),
where
the respective components have the following mole percentages:
meta-xylylene diamine (MXD): 20 to 80 mole-%,
hexamethylene diamine (6): 80 to 20 mole-%,
isophthalic acid (I): 60 to 80 mole-%, and
terephthalic acid (T): 40 to 20 mole-%,
each related to 100 mole-% of diamine and 100 mole-% of dicarboxylic acids.

50. The material composites according to claim 22, wherein said copolyamides comprise the composition of formula (C):
6I/6T/6NDC (C),
where
the respective components have the following mole percentages:
naphthaline dicarboxylic acid (NDC) having a symmetric or asymmetric substituent position, or
mixtures thereof, particularly 2,6-naphthaline carboxylic acid: 20 to 80 mole-%,
isophthalic acid (I): 80 to 20 mole-%,
terephthalic acid (T): 40 to 0 mole-%, and
hexamethylene diamine (6): 100 mole-%, which hexamethylene diamine may completely or partially be substituted by ethylene diamine, trimethyl hexamethylene diamine, or linear diamines having 8 to 12 CH₂-groups, or cycloaliphatic diamines such as norbomane diamine, 4,4 diaminodicyclohexyl methane, 3,3′-dimethyl-4,4′-diaminodicyclohexyl methane or mixtures thereof, each related to 100 mole-% of diamine and 100 mole-% of dicarboxylic acids.

51. The material composites according to claim 1, wherein said polyamides of said polyamide moulding compounds are polyamide blends consisting of
a polyamide having the composition of formula (I); and
at least one semicrystalline polyamide having the composition of formula (II), wherein the components of said polyamide (I) and said polyamide (II) are used in a ratio of 99:1 to 1:99, preferably 10:90 to 90:10, so that the sum equals 100 parts, wherein said polyamide (I) has the following monomer composition or is represented by chains of the following formulas (Ia) or (Ib): [symbol]
(OOC—X—COO [symbol] ₐ [symbol] HN—Y—NH [symbol] ₐ [symbol] OOC—Z—NH [symbol] _{b} [symbol] _{c} (Ia), [symbol]
(OOC—X₁—COO)ₐ₁(HN—Y₁—NH)ₐ₁(OOC—Z₁—NH)_{b1}]_{c1} (Ib),
where
X=iso-phenylene, para-phenylene,4-12 (CH₂) units, cyclohexyl, naphthyl, norbornyl, norbornane dimethyl, trimethyl hexamethylene,
X₁=iso-phenylene, para-phenylene 2-12 (CH₂) units, cyclohexyl, naphthyl, norbornyl, norbornane dimethyl, trimethyl hexamethylene,
Y=(CH₂): 2-12 (CH₂) units, cyclohexyl, bis-(methyl-cyclohexyl) methane, bis-(methylcyclohexyl) ethane, bis-(methyl-cyclohexyl) propane, norbornyl, norbomane dimethyl, trimethyl hexamethylene, bis-(cyclohexyl) methane, bis-( cyclohexyl) ethane, bis-(cyclohexyl) propane,
Y₁=(CH₂): 2-12 (CH₂) units, cyclohexyl, bis-(methyl-cyclohexyl) methane, bis-(methylcyclohexyl) ethane, bis-(methyl-cyclohexyl) propane, norbornyl, norbornane dimethyl, trimethyl hexamethylene, bis-( cyclohexyl) methane, bis-(cyclohexyl) ethane, bis-(cyclohexyl) propane,
Z=(CH₂): 4-12 (CH₂) units, cyclohexyl, bis-(methyl-cyclohexyl) methane, bis-(methylcyclohexyl) ethane, bis-(methyl-cyclohexyl) propane, norbornyl, norbornyl dimethyl,
Z₁=(CH₂): 4-12 (CH₂) units, cyclohexyl, bis-(methyl-cyclohexyl) methane, bis- (methyl-cyclohexyl) ethane, bis- (methyl- cyclohexyl) propane, norbornyl, norbornyl dimethyl, trimethyl hexamethylene, and
a=0-50 mole-%, b=0-100 mole-%, a₁=0-50 mole-%, b₁=0-100 mole-%, and the sum of a +a₁+b+b₁ is 100 mole-% and the sum of c+c₁ is 100% by weight;
and wherein said semicrystalline polyamide (II) is represented by chains of formula (IIa) and/or (IIb):
[(—HN-u-COO—)_{d}(—HN-v-COO—)ₑ(—HN-s-NH—)_{f}(—OOC-t-COO—)_{f}]_{g} (IIa),
[(—HN-ₛ₁-NH—)_{f1}(—OOC-ₜ₁-COO—)_{f1}]_{g1} (IIb),
where
u=(CH₂): 4-12 (CH₂) units, v=(CH₂): 4-12 (CH₂) units,
s, s₁=(CH₂): 2-12 (CH₂) units, meta-xylylene, para-xylylene,
t, t₁=(CH₂): 2-12 (CH₂) units, iso-phenylene, para-phenylene, and
f=0-50 mole-%, d=0-100 mole-%,
f₁=0 -50 mole-%, e=0-100 mole-%,
wherein the sum of f +fi +d +e is 100 mole-% and
the sum of g +gi is 100% by weight; and
at least 0.01 to 2.0 parts by weight of a phosphorus compound of formula (III), related to 100 parts by weight of said polyamides of formulas (Ia)/(Ib), (IIa)/(IIb), which may be used in a pure form or as an aqueous solution:
[X(R′)ₙP(O)₁(OR″)ₘ] (III),
where
X=H, —OR″, 2-pyridyl, —NH2, —NHR′, —NR′R″, wherein X may be bonded to (R′) or may be directly bonded to P,
R′=(CH₂)ₙ₁, linear or branched,
R′=Li, Na, K, H, (CH₂)ₙ₂, linear or branched, and
n=integer of 0 to 5; 1=0, 1, 1.5, 2, 2.5; m=integer of 0 to 3; n₁=integer of 1 to 12, n₂=1 to 12; and/or
0.01 to 15 parts by weight of cyclic phosphonic acid anhydride compounds of formula (IV), related to 100 parts by weight of said polyamides of formulas (Ia)/(Ib), (IIa)/(IIb), which may be used in a pure form or as an aqueous solution:
[—(R)PO(O)—]ₙ (IV),
where
n=3, 4, 5, 6, an alternating —P—O— heterocycle having 3, 4, 5, 6 (P—O) units in the ring,
R=CH₃, C₂H₅, C₃H₇, C₄H₉, isobutyl, 2,2,6,6-tetramethyl-4-piperidyl.

52. The material composites according to claim 25, containing 10 to 90% by weight of a polyamide (I) and 90 to 10% by weight of a semicrystalline polyamide (II).
